(19) United States
(12) Patent Application Publication
(10) Pub. No.: US 2003/0233476 A1
(43) Pub. Date: Dec. 18, 2003

(54) Transmitter device message prioritization

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/172,418

(22) Filed: Jun. 13, 2002

(51) Int. Cl. G06F 15/16

(52) U.S. Cl. 709/245

(57) ABSTRACT

An image is composed at a transmitter device from a scanned image. The scanned image is in a job in queue. The job has an electronic address and includes an address of a network resource on an interconnected network and a destination location thereat. The job also has a priority code not less than that of any other job in the queue, and a relative position higher than that of any other job in the queue that has the same priority code. A network message associated with the job and including the scanned image is then transmitted to the electronic address.

### FIELD OF THE INVENTION

The present invention relates generally to peripheral devices, and more particularly to prioritizing data to be sent by a transmitter device.

### BACKGROUND OF THE INVENTION

Many peripherals to computer networks include a scanner component. One example of such a peripheral is an “All-in-one”, also known as a multifunction peripheral (MFP) in that it has the capability to perform the multiple functions of scanning hardcopy documents, copying, and printing. Another example is a digital network copier that scans in documents from an automatic document feeder, does high volume copying, and has the capabilities of binding, collating, folding, stacking, stapling, stitching, edge-trimming, paginating, and printing on substrates of varied composition. Each of these peripherals, when in communication with an interconnecting network, can also be described as being a digital transmitter device. A digital transmitter device is an appliance that has an input device (e.g. a keyboard), a display, and a scanner. The digital transmitter device need not have a printer. A digital camera is a type of digital transmitter device, but in comparison to the foregoing, it is not as useful for handling documents and typically lacks the resolution and ability to rapidly and repetitively transfer information after scanning to a repository.

In an exemplary digital transmitting operation, a hardcopy of a document or other physical object can be presented to the scanner portion of a digital transmitter device. After scanning, the digital transmitter device transforms the scanned image into a digital representation that is then saved in a data format, such as in a bit map data format or in a Portable Document Format (PDF). Electronic messaging can be used to send an electronic mail (e-mail) from the digital transmitter device with an attachment of the digitized representation in the data format. The e-mail message can be sent to recipients over an interconnecting network, where the recipients have an e-mail address that a user manually enters at the digital transmitter device or that a user specifies using a predefined defined list of recipient e-mail addresses that can be stored in a memory of the digital transmitter device.

After documents have been scanned into a digital transmitter device, the transformation of the scanned images on each scanned document into a digital representation format can be time consuming. This transformation process is also known as document composing. In a corporate or office environment where a digital transmitter device is heavily used, each user places a set of documents in the scanning mechanism to be scanned and then composed. If the number of scanned documents exceeds the capacity of the digital transmitter device to compose the scanned documents, a queue of scanned documents can build up as a bottle neck to the throughput of the digital transmitter device. Some users may have more urgent e-mail message to be sent then other users whose e-mail message is not time sensitive. It would be beneficial to enable the prioritization of e-mail message from a digital transmitter device according to the user's needs. Consequently, there is a need for improved methods, systems, and programs that can provide such a capability.

### SUMMARY OF THE INVENTION

The above-stated needs and/or others are met, for example, by methods, systems, and programs for composing an image at a transmitter device from a scanned image. The scanned image is in a job in queue. The job has an e-mail address, a priority code not less than that of any other job in the queue, and a relative position higher than that of any other job in the queue that has the same priority code. An e-mail message that includes the composed image is transmitted from the transmitter device to the e-mail address.

These and other features of the present invention will become more fully apparent from the following description and appended claims, or may be learned by the practice of the invention as set forth hereinafter.

### DESCRIPTION OF THE DRAWINGS

A more complete understanding of the various methods, systems, and programs of the present invention may be had by reference to the following detailed description when taken in conjunction with the accompanying drawings wherein the same reference numbers are used throughout the drawings to reference like components and features, and wherein:

FIG. 1 is a block diagram, according to an embodiment of the present invention, depicting a computing and communication environment having digital transmitter devices in a system environment suitable for providing local access to the digital transmitter devices.

FIG. 2 illustrates various digital transmitter devices that provide local access for input thereto according to an embodiment of the present invention.

FIG. 3 is a block diagram, according to an embodiment of the present invention, illustrating a digital transmitter device in communication through a wired or wireless link to an interconnecting network to which a server is also in communication.

FIG. 4 illustrates an example of menu pages that might be displayed on a touch sensitive menu screen of a digital transmitter device and transition sequences among the menu pages, according to an embodiment of the present invention.

FIG. 5 illustrates an example, according to an embodiment of the present invention, of a prioritization table for prioritizing e-mail message to be sent from a digital transmitter device.

FIG. 6 is a flow diagram, according to an embodiment of the present invention, depicting a method for use in a computing and communication environment having a digital transmitter device in a system as in FIG. 1, for example, in accordance with certain exemplary embodiments of the present invention.

### DETAILED DESCRIPTION

The methods, systems, and programs described herein, according to various embodiments of the present invention, relate to the transmission of message data in an electronic mail (e-mail message) from a transmitter device to one or more e-mail address(es). When an e-mail message is sent from a digital transmitter device, message data attached to the e-mail message can include an image that has been composed or digitized from images of documents that were captured by the digital transmitter device using a scanning mechanism. The composition or digitizing process for the message data can be time consuming, depending upon various factors, such as the number of documents captured using the scanning mechanism. In the course of the operation of a digital transmitter device or a MFP, it is possible that a number of users will wish to scan in a stack of documents to be transmitted via e-mail to another digital transmitter device. This situation is typical in corporate environments where many users are often waiting to use a digital transmitter device. In order to satisfy the relative time sensitive needs of each user, each user is assigned a user ID. Each user ID is associated with an account having a certain amount of priority credit available to the user. The priority credit is an amount available to each user to prioritize an e-mail message the user wants to send over the priorities of other users.

When a user scans in a set of documents to a digital transmitter device to be sent in an e-mail message, the user also keys in his or her user ID and a priority code that is to be associated with the job of e-mailing the scanned documents. The digital transmitter device, or other network device, assesses a cost against the user's priority credit based upon the user's specified priority code for the e-mail message. The higher priority code that the user specifies, the higher the assessment against the user's priority credit.

In order to determined whether or not a user has sufficient priority credits remaining to send the scanned documents by e-mail with the priority code specified by the user, an inquiry is made to a location at which the users priority credit is stored, such as at a network device (e.g. a server) in communication with the digital transmitter device, or at the digital transmitter device itself. The inquiry can use the User ID as the code for accessing the storage location to obtain the balance of the user's priority credits. The storage location will preferably contain a priority credit account for each user ID on a particular network or for a particular digital transmitter device. Alternatively, the priority credit account file can contain the user ID and a respective priority credit balance for a plurality of digital transmitter devices that are in communication with a common interconnected network.

The result of the inquiry is the return of the balance of the user's priority credit to the digital transmitter device. The digital transmitter device then makes a computation of the cost of the priority code specified by the user for the scanned document e-mail job and determines whether or not there is sufficient balance remaining. If there is an insufficient balance left in the user's priority credit account, then the digital transmitter device will display a diagnostic indicating an insufficient balance for the specified priority code. The user then may input a lower priority code. This procedure can continue until a priority code has been input by the user for which there is a sufficient balance in the user's priority credit account. Upon acceptance, the balance of the user's priority credit account is updated to reflect a deduction for the specified priority code.

A routine to replenish the user's priority credit periodically, or upon another specific event, can also be implemented. For example, such replenishment can be based on the frequency that the user specifies high priority e-mail message transmissions at digital transmitter devices. As an alternative, the assessment process can be arranged such that no assessment is made of the user's priority credits in certain circumstances. For example, no assessment can be made when the user specifies one of the lower priority codes or when the user uses a digital transmitter device at a period of low usage, such as when there are no documents being composed or waiting to be composed.

The location of each user's priority credit data on a network can be quite diverse. For example, a digital transmitter device may function independently with each user's User ID and priority credit balance being maintained by the digital transmitter device. As such, the digital transmitter device would perform the calculations for each user to determine if a sufficient balance remains in the respective priority credit account to send an e-mail message with the priority code specified by the user. In this case, a query need not be made to another network device, such as a server, with which the digital transmitter device is in communication through an interconnected network. Exemplary System for Configuration of a Digital transmitter device

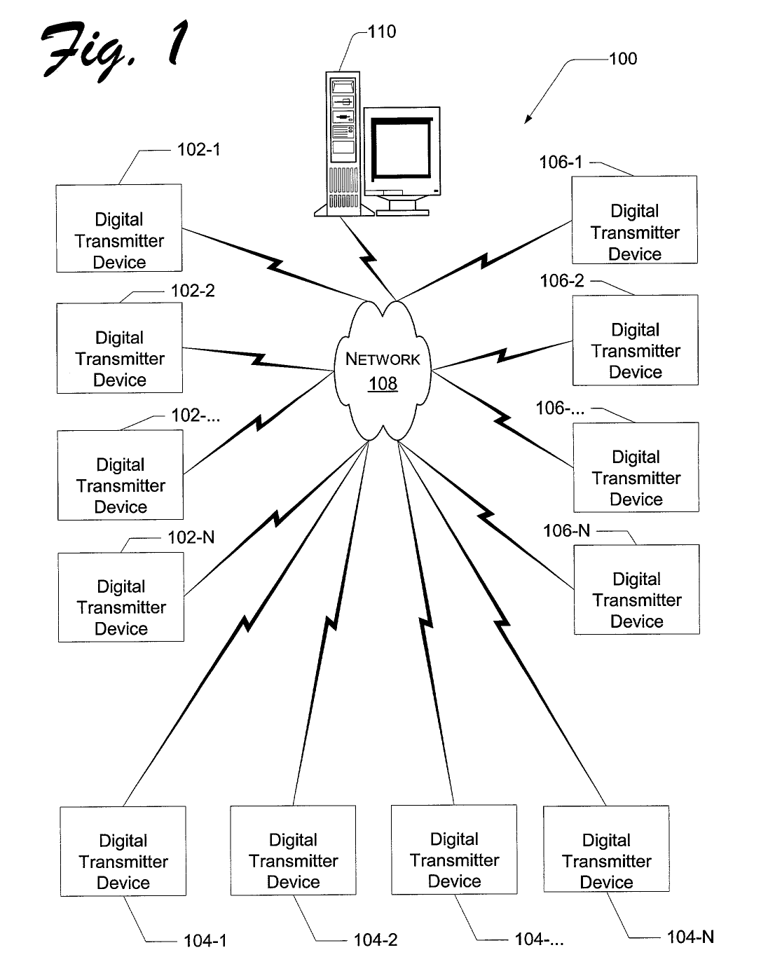

FIG. 1 illustrates an example of a system environment 100 suitable for implementing an embodiment of the present invention. The system environment 100 contemplates a plurality of digital transmitter devices 102-1 through 102-N, 104-1 through 104-N, and 106-1 through 106-N. Each digital transmitter device 102-i, 104-i, and 106-i is in communication with an interconnected network 108. Interconnected network 108 is in communication with one or more server(s) 110. Each server 110 can be an e-mail server that serves one or more e-mail addresses to which any digital transmitter device 102-i, 104-i, and 106-i can send e-mail message.

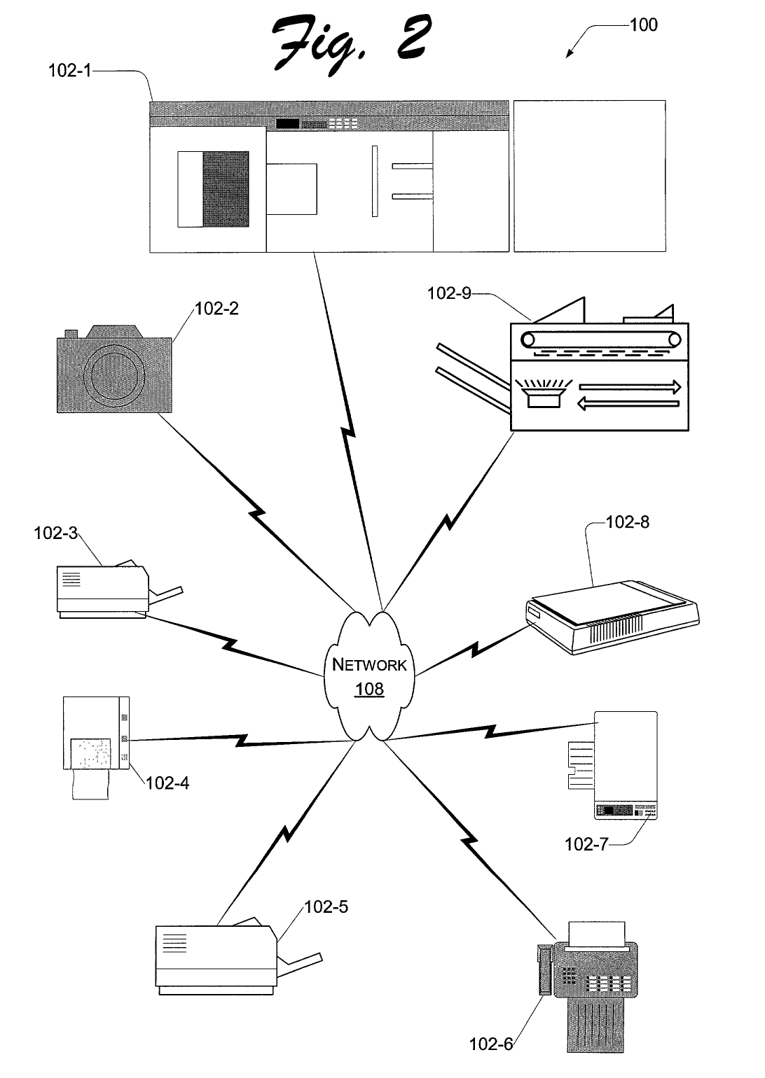

Digital transmitter devices 102-i, 104-i, and 106-i generally include peripheral devices and stand-alone devices. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Digital transmitter devices 102-i, 104-i, and 106-i therefore include copiers, scanners and fax machines such as those shown in FIG. 2, discussed below.

Digital transmitter devices 102-i, 104-i, and 106-i are generally distinguishable from devices such as laptop PCs (personal computers) and pocket PCs by their limited purpose and limited user interface or input/output capabilities. For example, a typical user interface for a digital transmitter device 102 includes a front menu panel with limited screen space and a limited number of buttons. In addition, a digital transmitter device 102-i, 104-i, and 106-i is typically oriented toward performing one general task such as scanning. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

Interconnecting network 108 is representative of one or more communication links, either wired or wireless, that are capable of carrying data between server 110 and other network resources in communication with interconnecting network 108. In certain exemplary implementations, interconnecting network 108 includes a local area network (LAN), a wide area network (WAN), an intranet, the Internet, or other similar network.

Local access to each digital transmitter device can be provided through an input device, such as a touch sensitive menu screen, at each digital transmitter device 102-i, 104-i, and 106-i. A user accesses the input device via a user interface for the purpose of entering commands, a User ID, one or more e-mail addresses, message text, and a priority code for each e-mail message the user wishes to send. Alternatively, a default email address or a list of selectable e-mail addresses can also be stored at each digital transmitter device 102-i, 104-i, and 106-i. Preferably, each digital transmitter device 102-i, 104-i, and 106-i will have an imaging or scanning mechanism to receive images of an object. A document composer component in each digital transmitter device 102-i, 104-i, and 106-i then can digitize the images of the scanned object. The composed documents can then be sent in a file attached to an e-mail message that is addressed to the input, default, or selected e-mail address from digital transmitter device 102-i, 104-i, and 106-i through interconnected network 108 to one or more e-mail servers for the respective one or more e-mail addresses input or specified by the user.

FIG. 2 shows a variety of digital transmitter devices 102-1 through 102-9 that can be in communication with interconnected network 108. Digital transmitter device 102-2 is intended to represent both a digital camera and a type of portable hand held scanner to capture and digitize images. The camera and the portable hand held scanner capture images is a fashion that can be mobile relative to the object from which the image is to be captured. Each of the camera and the portable hand held scanner can have a document composer component to digitize images captured thereby. Also shown are various multifunction peripherals (MFPs) 102-3 through 102-5, 102-7, and 102-9. FIG. 2 also depicts a facsimile machine 102-6, a desk top scanner 102-8, and a high volume copier 102-1 which includes some or all of the capabilities of printing on substrates of varied composition, binding, collating, folding, stacking, stapling, stitching, edge-trimming, and paginating.

The user of digital transmitter device 102-i, 104-i, and 106-i as seen in FIG. 1 can transmit message data to interconnected network 108 by a wired or wireless link. A wireless link can be through an Infrared (IR) data connection or other wireless data connections such as the Blue Tooth protocol. The wireless link may be made through radio frequency (RF) or infra-red (IR) data ports. By way of example, digital transmitter device 102-i, 104-i, and 106-i can include the capabilities of a cordless handset telephone, a cellular telephone, a personal digital assistant (PDA), a pager, a watch and the like, any of which is also capable of transmitting data in a wireless manner. A wired link can be performed through a USB data connection, a serial port connection, a parallel port connection or via other known data transmission standards and modes. The wired link may be implemented through standard RS232 cable, Universal Serial Bus (USB) cable, or Fire Wire™ connection data ports. As such, digital transmitter device 102-i, 104-i, and 106-i can transmit by one or both of a wireless or wired link. Exemplary System for a Digital Transmitter Device in Communication with a Server

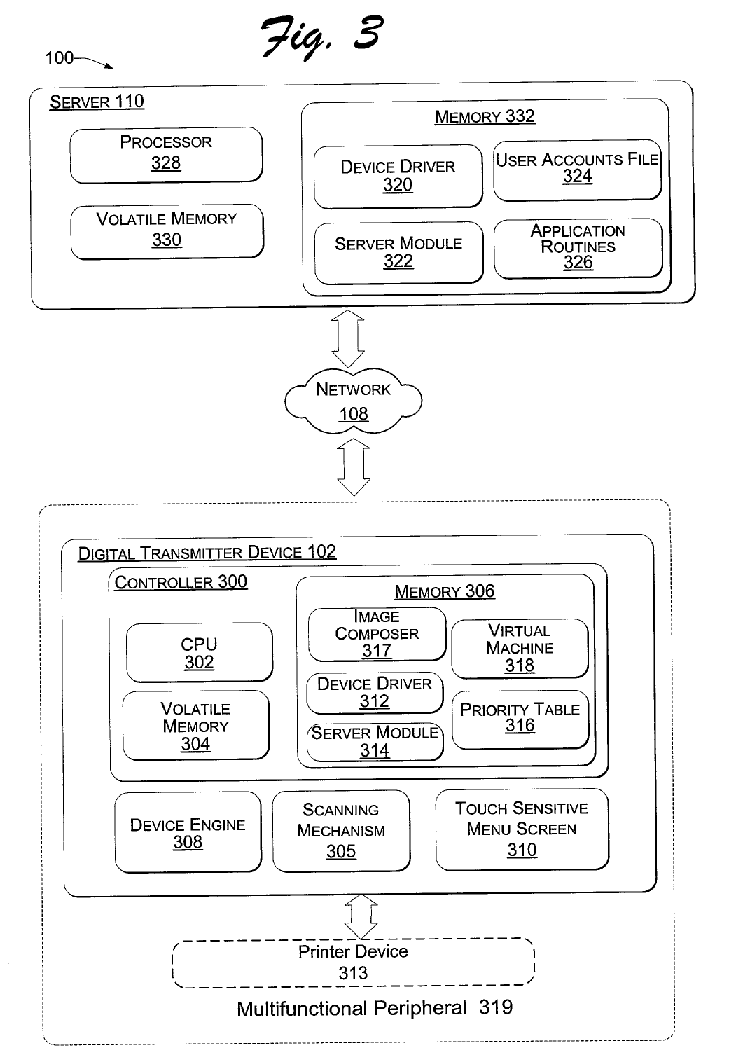

The system 100 of FIG. 3 includes digital transmitter device 102 as a peripheral device coupled by a wired or wireless link to interconnecting network 108 and to server 110 through interconnected network 108. As such, FIG. 3 illustrates an embodiment of the system 100 of FIG. 1 in greater detail. In accordance with still other aspects of the present invention, digital transmitter device 102 may be included within a multiple function peripheral (MFP) device 319. As its name implies, the MFP device 319 is configured to provide multiple functions. In this example, the functions provided by the MFP device 319 include those provided by digital transmitter device 102 and a printer device 313. Consequently, the user of digital transmitter device 102 may also print out a hardcopy of any applicable portions of data stored or otherwise acquired by digital transmitter device 102.

In general, digital transmitter device 102 uses a controller 300 to execute a program to compose documents from images that are captured by scanning documents or other objects using a scanning mechanism 305. The program to compose documents can be stored in a memory 306 or in scanning mechanism 305. Controller 300 also executes a program so as to transform data to a driver format suitable for printing with integral printer device 313, such as a mark up language format (e.g. SMGL, HTML, or XML), or such as a job language format (e.g. PCL or postscript). Printer device 313 can have the capability of converting data and then outputting it onto an appropriate print media, such as paper, transparencies or glossy photo paper.

Digital transmitter 102 includes one or more CPUs 302, each of which is operatively coupled to memory 306, and a user interface that includes an input device. Preferably, the input device will be locally accessible at digital transmitter device 102. By way of example, the input device can be a touch sensitive menu screen 310. Digital transmitter device 102 also includes at least one communication port for interfacing with interconnecting network 108 through either a wired or wireless link.

When included in MFP device 319, CPU(s) 302 would also be operatively coupled to printer device 313, for example. CPU(s) 302 is representative of any hardware, firmware and/or software that is configured to perform certain functions associated with the operation of digital transmitter device 102. Hence, as those skilled in the art will recognize, CPU(s) 302 may include dedicated logic and/or one or more processors configured in accord with software instructions, for example.

Memory 306 is representative of any type of data storage mechanism that can be accessed by at least CPU(s) 302. Memory 306 may therefore include, for example, some form of random access memory (RAM), some form of read only memory (ROM), and/or other like solid-state data storage mechanism. Memory 306 may include a magnetic and/or optical data storage mechanism. Scanning mechanism 305 is representative of any optical scanner technology that may be employed to produce scanned object data upon scanning an object. Such scanning technologies are well known. The resulting scanned object data is provided to CPU 302 and/or stored in memory 306.

Controller 300 of digital transmitter device 102 typically includes data processing unit or CPU 302, a volatile memory 304 (i.e., RAM), and a non-volatile memory 306 (e.g., ROM, Flash). Digital transmitter device 102 also includes a device engine 308. The touch sensitive menu screen 310 acts as a local user interface for digital transmitter device 102 by displaying menu pages and accepting user input based on selectable menu items displayed on the menu pages. The touch sensitive menu screen 310 can be used to display a menu page that asks for and receives the input of an e-mail address to which to image data that is scanned with scanning mechanism 305 is to be transmitted in an e-mail message via interconnected network 108.

Controller 300 processes data and manages device functions by controlling device engine 308 and by responding to input from touch sensitive menu screen 310. Device driver software in a device driver 312 can be stored in memory 306 and executed on CPU(s) 302. Memory 306 also includes a server module 314 configured to serve menu documents to the touch sensitive menu screen 310. The server module 314 is a local server in the sense that it is present within the same digital transmitter device 102 to which it serves menu documents.

Controller 300 includes a Priority Table 316 that is stored in memory 306. Priority Table 316 keeps a balance for each user identification code (User ID). The balance reflects available priority credits to the User ID. Each time that a user specifies a priority code in sending an e-mail message, the user's balance is reduced as a function of the priority code specified by the user. Digital transmitter device 102 can be set up to initialize, replenish, or otherwise increment the balance of one or more priority credits corresponding to one or more User IDs. Alternatively, server 110 can perform this function.

Menu documents stored in memory 306 can be interpreted by the server module 314 and are configured to display textual and graphical information as menu pages on the touch sensitive menu screen 310. The menu documents driving the menu pages can include script code that is associated with graphical keys. The term “script code” is intended herein to mean any one of a variety of different code types. Various kinds of code are contemplated. By way of example, the code can be implemented in embedded script code, in firmware, in a native code such as C++ code, or can be JAVA script. The code can be written in JavaScript code that is interpreted and executed on a Java Virtual Machine (JVM). The code can also be written in other script code languages such as VBScript or Perl.

Selecting a menu item by pressing a graphical key on the touch sensitive menu screen 310 triggers an event which causes a “virtual machine” 318 to interpret and execute the script code associated with the selected graphical key. The virtual machine 318 is a software module stored in memory 306 that executes on CPU(s) 302 to interpret and execute script code. The script code can be associated with selectable menu items (i.e., graphical keys or buttons). One menu item is configured to perform the task of initiating a scan of an image using scanning mechanism 305. Another menu item is configured to perform the task of receiving input of a User ID, a priority code, and one or more e-mail address(es) to which e-mail message data is to be sent via interconnected network 108. Still another menu item can be configured to perform the task of initiating a retrieval of an e-mail address that was previously stored in memory 306. Memory 306 can optionally contain e-mail address information that can be requested to be displayed upon touch sensitive menu screen 310. When the e-mail address information is retrieved from memory 306, the user can select a displayed e-mail address to which an e-mail message will be transmitted over interconnected network 108 to another digital transmitter device 104-i or 106-i as seen in FIG. 1. Alternatively, the user can directly enter a specific e-mail address into the digital transmitter device 102 using touch sensitive menu screen 310. Controller 300 executes processes resident in a communicative link interface for transmission over a wired and/or wireless link to interconnected network 108.

When a user enters a command displayed upon touch sensitive menu screen 310 to start a scanning operation, the user places a set of documents into a sheet feeder device associated with digital transmitter device 102. The sheet feeder device then physically serves each sheet in the set of documents to scanning mechanism 305. CPU 302 then generates a bit map or other output that is a digital representation of the scanned documents in a document composition process. The document composition process digitizes the scanned object data so that it can be included in e-mail message data as an attached file. It is preferred that digital transmitter device 102 be able to perform a variety of document composition routines for a plurality of data formats, including Portable Document Format (PDF) formatted data, graphical image file format (GIFF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc.

When the user enters a command displayed upon touch sensitive menu screen 310 to enter or retrieve an e-mail address, digital transmitter device 102 coordinates the input of the e-mail address. Controller 300 then executes a user message compositing routine, preferably stored in memory 306, that assembles message data. The message data so assembled includes the e-mail address input or otherwise designated by the user, the bit map or other output that is a digital representation of the scanned documents, and can also include any message text entered by the user upon touch sensitive menu screen 310. The message data is then sent by a wired and/or wireless link to interconnected network 108. From interconnected network 108 a communication is established with an e-mail server that is also in communication therewith. The e-mail server provides the email address to which the e-mail message from digital transmitter device 102 is to be sent. By way of example server 110 can, but need not, function as the e-mail server of any e-mail message address of digital transmitter devices 102-i, 104-i, and 106-i seen in FIG. 1. A server in communication interconnected network 108, other than server 110, can be the e-mail server for e-mail addresses associated with digital transmitter devices 102-i, 104-i, and 106-i.

CPU(s) 302 is configured to perform the operations described above using various executable modules of memory 306, such as an e-mail address storage/retrieval routine, a communicative link interface routine, and a user message compositing routine, any of which can each be implemented in software or firmware.

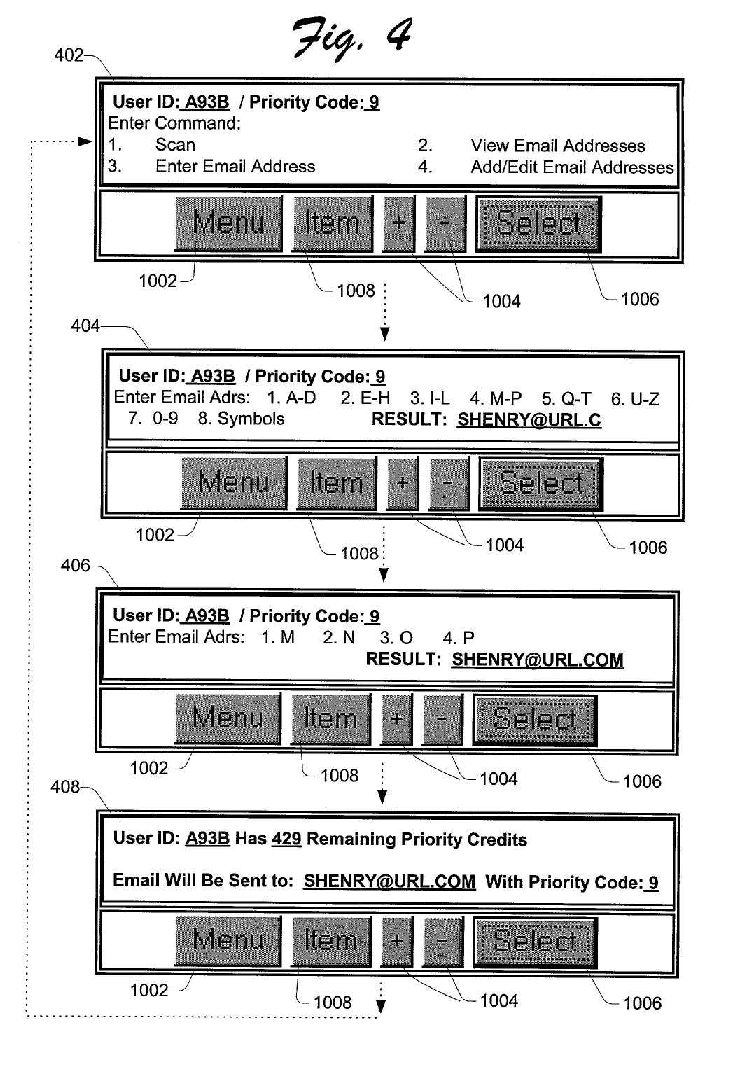

In one embodiment of the invention, an e-mail address storage/retrieval routine executing on CPU(s) 302 receives input of an e-mail address from a user at touch sensitive menu screen 310 or retrieves a list of stored e-mail addresses. The list of e-mail addresses are displayed on touch sensitive menu screen 310 in a hierarchical list. The list can be sorted alpha-numerically. The user can either select from among the displayed e-mail addresses or input the characters of a specific e-mail address using a ‘drill-down’ function of the menu, as discussed below with respect to FIG. 4. The drilldown menu format and the displayed list of retrieved e-mail addresses assist the user in locating an e-mail address of interest.

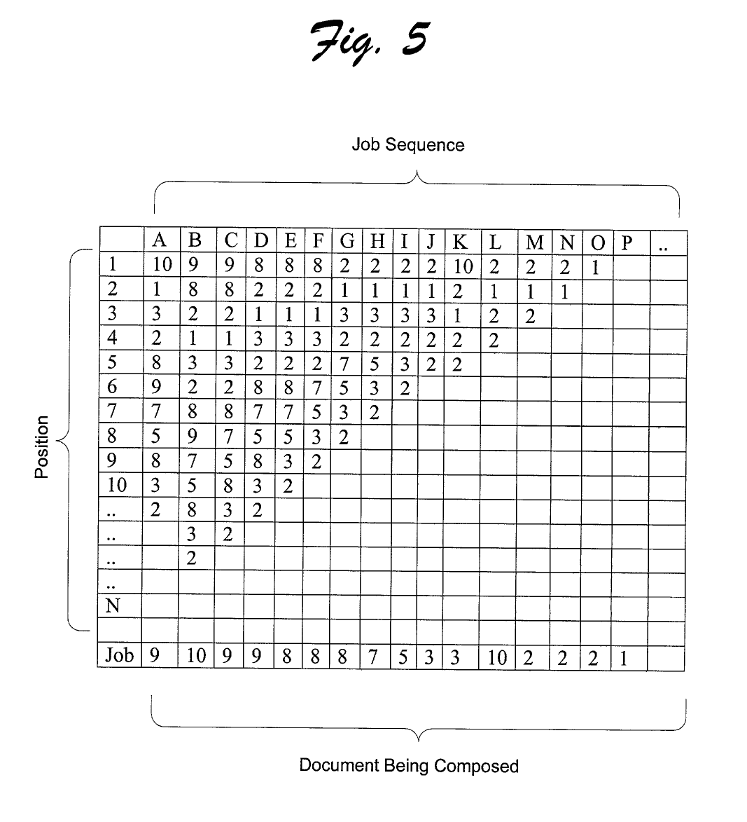

FIG. 3 shows server 110 in communication with interconnected network 108 and having a processor 328, a volatile memory 330, and a memory 332. Memory 332 includes a device driver 320, a server module 322, a User Accounts File 324, and application routines 326 for storage of software. While priority table 316 in digital transmitter device 102 can be used as a repository for all User IDs and a respective balance of priority credit therefore, it is also contemplated that User Accounts File 324 in memory 332 of server 110 can be a repository for all User IDs and a respective balance of priority credit therefore. In this case, server 110 maintains the User ID and the priority credits for each User ID over which sever 116 is intended to have monitoring responsibility. Application routines 326 is a storage location for programs that can be executed by processor 328 on server 110. One such routine is a routine to maintain the contents of the User Accounts File 324, discussed below with respect to FIG. 5.

As mentioned above, a user interface device can be used to accept the input of an e-mail address from a user at the digital transmitter device. By way of example, a sequence of menus that can be displayed upon touch sensitive menu screen 310 of digital transmitter device 102 are seen in FIG. 4. The menus depicted in FIG. 4 illustrate a ‘drill-down’ function. A menu screen 402 is displayed upon touch sensitive menu screen 310 of digital transmitter device 102. Menu screen 402 shows various options to be selected by a user of digital transmitter device 102. Additionally, menu screen 402 shows that the user has already input the User ID A93B and a Priority Code of 9 using touch sensitive menu screen 310.

When the user selects option “1” on menu screen 402, digital transmitter 102 activates scanning mechanism 305 to scan in documents as discussed above. When the user selected option “3”, menu screen 404 is displayed to receive input from the user directly entering each character of a desired e-mail address using virtual buttons displayed upon menu screens 404-406.

After menu screen 402, menu screen 404 is displayed upon touch sensitive menu screen 310 of digital transmitter device 102. Menu screen 404 shows a practical example of a user selecting characters for a desired e-mail address. Menu screen 404 is presented by script code executing in CPU(s) 302 that allows the user to see alphabetic and symbolic characters by depressing virtual buttons 1004 to move forward and backward through a displayed hierarchical list of available alphabetic and symbolic characters. Script code executes in CPU(s) 302 to enable a user to select a displayed character by depressing virtual button 1006. The user can select a sequence of characters by depressing virtual buttons 1004 to thereby move forward and backward through the sequence of characters. Alphabetic and symbolic sequences of characters can be selected by the user on menu screen 404. By depressing virtual button 1006, the user can select a particular sequence of characters that is displayed. Menu screen 404 shows that a user has entered a partial e-mail address “SHENRY@URL.C”.

As seen in menu screen 406, the sequence of characters ‘M-P’ has been selected by the user by depressing virtual button 1006. The user then selects one character of characters M-P by depressing virtual buttons 1004 to thereby move forward and backward through the characters M-P. Menu screen 406 shows that the characters “O” and “M” where selected from the characters M-P so as to complete the desired e-mail address “SHENRY@URL.COM”. Then, when virtual button 1006 is depressed on menu screen 406, the user sees a transition to menu screen 408 where a diagnostic can be displayed. In this case, the diagnostic shows that the e-mail message transmission has been scheduled and that User ID has a remaining balance of 429 priority credits after a deduction has been made for sending a priority ‘9’ e-mail message from the digital transmitter device.

As an alternative to the foregoing sequence of menu screens and displays thereon, menu screen 402 can reflect the result of a query to server 110, as seen in FIG. 3, and then a display of the remaining balance of priority credits for User ID A93B prior to an e-mail message that is to be sent with a priority code of 9.

After menu 408, a transition is made back to menu screen 402 where the user can enter another command as discussed above. In transmitting the e-mail message, digital transmitter device 102 composes the scanned document(s) and assembles message data to be sent in an e-mail message through interconnecting network 108 to the e-mail address that was selected or otherwise entered by the user, as discussed above. Other virtual buttons displayed on the touch sensitive menu screen 310 are also contemplated in order to provide for the initiation of other or additional functions by the user, such as an item virtual item button 1008 seen in FIG. 4.

FIG. 5 shows one example of the contents of priority table 316 of memory 306 of digital transmitter device 102. The table of FIG. 5 shows positions 1 through N and also shows job sequences A through P. Also seen in FIG. 5 is the job being processed in each Job Sequence. As seen in the first column of table of FIG. 5, the job being processed at Job Sequence A has a priority code of 9. Also seen in the first column of table of FIG. 5 is that Job Sequence A has a queue that includes: in position 1 a priority job 10; in position 2 a priority job 1; in position 3 a priority job 3; in position 4 a priority job 2; in position 5 a priority job 8; in position 6 a priority job 9; in position 7 a priority job 7; and in position 8 a priority job 5; etc. Job Sequence B shows that a job having priority 10 is being processed. Job Sequence B also shows that there are two jobs that have number 9 priority codes.

The process for determining which job in any of Job Sequences A through P will be processed is as follows. When the digital transmitter becomes available to compose documents for a set of scanned in documents in a job, the job that will be selected for the next Job Sequence will be that job in the current Job Sequence that has a priority code that is not less than that of any other job in the queue, and that has a relative position higher than that of any other job in the queue that has the same priority code. When a user scans in a set of documents, the position that the user's job takes in a job sequence column of the table of FIG. 5 is the lowest numbered position. As subsequent sets of documents are scanned in to create new jobs, each new job takes the lowest numbered position (e.g. position number 1) and the previously scanned job is incremented by one position (e.g. position number 2). Thus, the position 1 becomes position 2, the position 2 becomes position 3, and the position 4 becomes position 5, etc. As such, when the digital transmitter device becomes available to compose the documents of scanned in documents, the job that is selected to be composed will be that job that has a priority code that is not less than that of any other job in the queue, and that has a relative position higher than that of any other job in the queue that has the same priority code. When two entries in one Job Sequence column have the same priority, where one job has a higher numbered position than the other, then the job with the highest numbered position will be the job processed by the digital transmitter device. A job in a Job Sequence that has a higher priority code and a lower numbered position will be processed before another job in the same Job Sequences that has a higher numbered position and a lower priority code.

A review of FIG. 5 reveals that jobs having a priority code of 1 are performed last and jobs having a priority code of 10 are performed first. By way of example, Job Sequence D shows a priority code 8 at positions 9, 6, and 1. As such, the job at position 9 will be processed in Job Sequence E since the tie is won by the highest numbered position. Job Sequence H shows the highest priority code to be 5 at position 5. As such, the job at position 5 will be processed in Job Sequence I since it has the highest priority code in Job Sequence H.

Exemplary Embodiment of Digital Transmitter Device Capture and Prioritized E-Mail

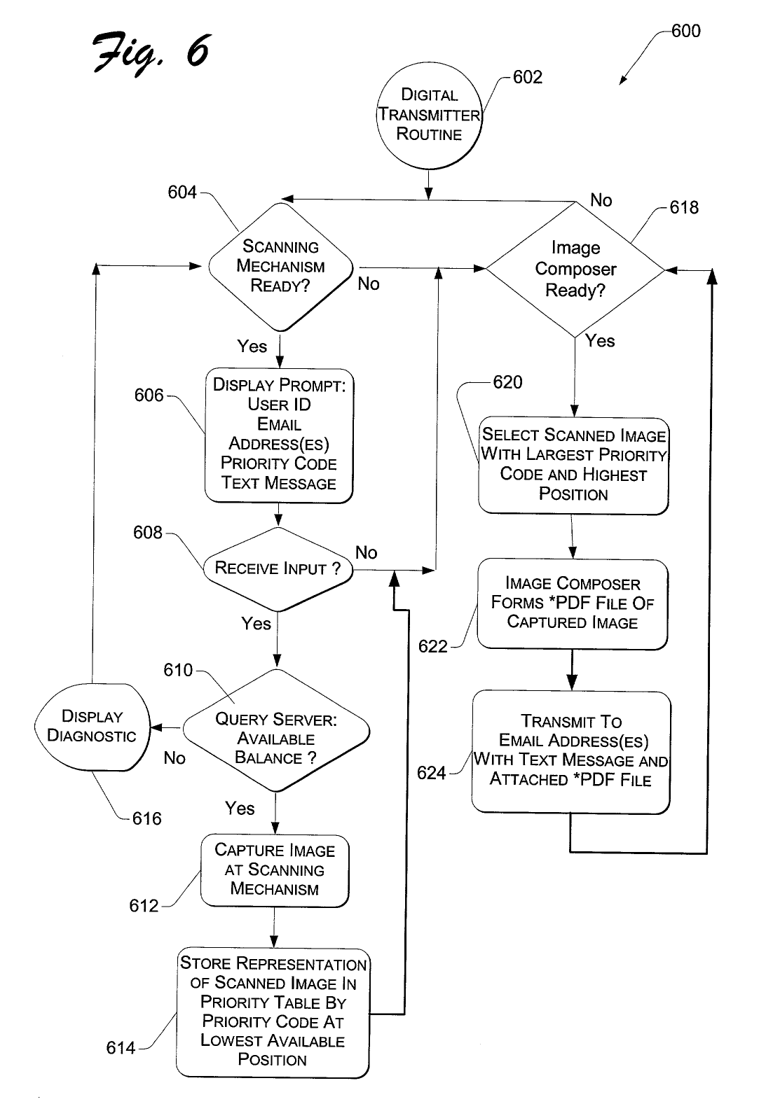

FIG. 6 shows a flow diagram, according to an embodiment of the present invention, depicting a method for using a digital transmitter device. With this in mind, CPU(s) 302 can be configured to perform the operations described below. By way of further example, a flow diagram is depicted in FIG. 6 to illustrate certain exemplary functions that can be performed using CPU(s) 302 and the other resources in digital transmitter device 102. Here, a process 600 is provided.

FIG. 6 illustrates a process 600 performing a routine for prioritizing jobs to be sent via e-mail by a digital transmitter device. The method begins at step 602 which directs a process flow to step 604. At step 604, a query is made as to whether the scanning mechanism of the digital transmitter device is ready. If so, the process 600 moves control to step 606 where digital transmitter device 102 displays a prompt on touch sensitive menu screen 310. In order to display the prompt, it is preferable that the server module 314 of memory 306 in digital transmitter device 102 provides a menu page that is stored in memory 306 to CPU 302 for execution of script code. The script code being executed by CPU 302 effects a function to be performed by digital transmitter device 102, such as receiving input from a user that is entered upon touch sensitive menu screen 310, or the initiation of a function by the user depressing a function related virtual button that is displayed on touch sensitive menu screen 310. The script code will preferably be executed in conjunction with an interpretation of the menu page. Note that in certain implementations, the menu page can be directly interpreted by script code executing on CPU 302 without any prior storage in menu documents in memory 306 or use of server module 314 in digital transmitter device 102.

If, at step 604 the scanning mechanism is not ready, then the process flows to step 618. If the scanning mechanism is ready to scan a first or a subsequent set of documents, then the process control moves to step 606 where the user is prompted to enter various input upon a user interface to the digital transmitter device. By way of example, such a user interface could be touch sensitive menu screen 310 of digital transmitter device 102 as seen in FIG. 3. The user enters, at step 608, a User ID, one or more e-mail addresses, a priority code, and an optional text message to be sent with the e-mail message. It is determined at step 608 whether or not the user has made input to the user interface. If the user has not made input to the user interface then the process 600 passes control to step 618. If, however, user has made input using the user interface at step 606, then the process moves to step 610.

At step 610, a network device, such as server 110 seen in FIG. 3, is queried to determine whether or not the input User ID has a high enough balance of priority credits to send the requested e-mail message given the input priority code. By way of example, User Accounts File 324 of memory 322 in server 110, as seen in FIG. 3, can be queried to obtain the priority credit balance for the respective User ID and thereby determine whether or not there is sufficient balance remaining in the respective User's account. If the remaining balance is not sufficient given the input priority code, then a diagnostic is displayed to the user on the user interface at step 616 and the process 600 returns control to step 604. If there is sufficient balance remaining, then process 600 proceeds to step 612 where the scanning mechanism scans in the documents at the scanning mechanism for storage at the digital transmitter device.

Process 600 then passes control to step 614 where the scanned image takes on a representation in a priority table. The representation takes the lowest position in the table with the priority code that was input by the user. An example of this table has been discussed above with respect to FIG. 5. After step 614, process 600 passes control to step 618 where it is determined whether or not the image composer component of the digital transmitter device is ready to compose another set of scanned in documents for subsequent e-mail message transmission. By way of example, digital transmitter device 102 has in memory 306, and/or scanning mechanism 305, algorithms, software, firmware, or other process control means for composing documents, as was discussed above.

At step 614, it is determined whether or not digital transmitter device 102 is prepared to compose another set of documents from a previously scanned set of documents. Process 600 then proceeds to step 620 where the priority table 316 in memory 306 is queried to determine, for a particular Job Sequence in the priority table 316, which job is to be composed next. The priority code and relative position of each job in the forthcoming Job Sequence is examined to find the job that has a priority code that is not less than that of any other job in the queue, and that has a relative position higher than that of any other job in the queue that has the same priority code. At step 622, the image composer component of the digital transmitter device composes the documents using the set of scanned documents for the selected job from step 620. At step 624, an e-mail message is assembled and transmitted to the one or more e-mail addresses input by the user at step 606. Attached to the e-mail message is a file containing the composed document containing the digitized images of the set of scanned documents for the job. After the transmission of the e-mail message to step 620 at step 624, the process returns to step 618 where another query is made as to whether or not the image composer is ready for another document. If the image composer is determined not to be ready at step 618, then the process 600 passes control to step 604 for a query as to whether the scanning mechanism is ready to scan another set of documents.

Process 600 repeats the foregoing procedure. The procedural repetition enables documents to be scanned when the scanning mechanism of the digital transmitter device is ready. The repetition also sequences jobs for submission to the image composer component of the digital transmitter device when it is available. When such availability of established, the next job is determined by priority and position, and the corresponding set of scanned in documents are composed for subsequent attachment to an e-mail message and transmission to one or more e-mail addresses input by the user upon the user interface of the digital transmitter device.

The foregoing Detailed Description has set forth an example of transmitting an email message from a digital transmitter device. Embodiments of the present invention contemplate other types of data that can also be addressed and transmitted by a transmitter device to an electronic address, including those now known and those yet to be developed. As such, and in addition to an e-mail message transmission, embodiments of the present invention include a transmission from a digital sender device to an electronic address that includes an address of a network resource on a network and a destination location thereat. By of example, and not by way of limitation, the electronic address can be a file folder address at a server on a network and can also be a Web site address at a server on a network.

Thus, although some preferred embodiments of the various methods, systems, and programs of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. A computer-readable medium having computer-executable instructions which, when executed on a processor, direct a computer to perform a method comprising:
composing an image at a transmitter device of an optically scanned image for a job in a queue, the job having:
an electronic address including an address of a network resource and a destination location thereat;
a priority code not less than that of any other job in the queue; and
a relative position higher than that of any other job in the queue having the same priority code; and
transmitting a network message including the composed image to the electronic address associated with the job.

2. The computer-readable medium as defined in claim 1, wherein the transmitter device is selected from the group consisting of a digital camera, a hand held scanner, a desk top scanner, a fax machine, a copier, a multifunction peripheral (MFP), and a digital network copier.

3. The computer-readable medium as defined in claim 1, wherein the electronic address is selected from the group consisting of:
an electronic mail (e-mail) address at an e-mail server on a network;
a file folder address at a server on a network; and
a Web site address at a server on a network.

4. The computer-readable medium as defined in claim 1, wherein the composed image has a format selected from the group consisting of an ASCII formatted data format, a word processor format, a spread sheet data format, a PDF data format, a Microsoft Power Point® software data format, a GIFF data format, a TIFF data format, a JPEG data format, a bit-map data format, an OCR data format, and an encoded data format.

5. A computer-readable medium having computer-executable instructions which, when executed on a processor, direct a computer to perform a method comprising:
comparing a queue of jobs each having:
an optically scanned image to be composed by a transmitter device for transmission of a network message to an electronic address including an address of a network resource and a destination location thereat;
a priority code; and
a relative position in the queue;
composing the optically scanned image and transmitting the network message containing the composed image to the electronic address associated with the job having a priority code not less than that of any other job in the queue and a relative position higher than that of any other job in the queue that has a priority code equal thereto.

6. The computer-readable medium as defined in claim 5, wherein the transmitter device is selected from the group consisting of a digital camera, a hand held scanner, a desk top scanner, a fax machine, a copier, a multifunction peripheral (MFP), and a digital network copier.

7. The computer-readable medium as defined in claim 5, wherein the electronic address is selected from the group consisting of:
an e-mail address at an e-mail server on a network;
a file folder address at a server on a network; and
a Web site address at a server on a network.

8. The computer-readable medium as defined in claim 5, wherein the composed image has a format selected from the group consisting of an ASCII formatted data format, a word processor format, a spread sheet data format, a PDF data format, a Microsoft Power Point® software data format, a GIFF data format, a TIFF data format, a JPEG data format, a bit-map data format, an OCR data format, and an encoded data format.

9. A computer-readable medium having computer-executable instructions which, when executed on a processor, direct a computer to perform a method comprising:
comparing a user account balance to determine whether a predetermined credit amount is available in the user's account;
if the predetermined amount is available, optically scanning at a digital transmitter device an image and storing the scanned image with an electronic address and the priority code as a job in a queue of other jobs, wherein the electronic address includes an address of a network resource on a network and a destination location thereat;
composing the scanned image and transmitting a network message containing the composed image to the respective electronic address for the job having:
the priority code thereof that is not less than that of any other said job in the queue; and
a relative position higher than that of any other said job in the queue that has a priority code equal thereto.

10. The computer-readable medium as defined in claim 9, further comprising outputting a diagnostic when the predetermined credit amount is not available.

11. The computer-readable medium as defined in claim 9, wherein:
comparing a user account balance to determine whether a predetermined credit amount is available that is a function of a priority code comprises:
retrieving the user account balance from a server on the network;
when the predetermined amount is available, the method further comprises:
deducting the predetermined amount from the respective balance for the User ID and storing the respective balance for the User ID at the server on the network.

12. The computer-readable medium as defined in claim 9, wherein the digital transmitter device is selected from the group consisting of a digital camera, a hand held scanner, a desk top scanner, a fax machine, a copier, a multifunction peripheral (MFP), and a digital network copier.

13. The computer-readable medium as defined in claim 9, wherein the electronic address is selected from the group consisting of:
an e-mail address at an e-mail server on the network;
a file folder address at a server on the network; and
a Web site address at a server on the network.

14. The computer-readable medium as defined in claim 9, wherein the composed image has a format selected from the group consisting of an ASCII formatted data format, a word processor format, a spread sheet data format, a PDF data format, a Microsoft Power Point® software data format, a GIFF data format, a TIFF data format, a JPEG data format, a bit-map data format, an OCR data format, and an encoded data format.

15. In a digital transmitter device capable of transmission of a network message on a network and having an input device, a computer-readable medium having computer-executable instructions which, when executed on a processor of the digital transmitter device, direct the digital transmitter device to perform a method comprising:
receiving at the input device:
an electronic address including an address of a network resource on the network and a destination location thereat;
a priority code; and
a User ID;
retrieving at the digital transmitter device a respective credit balance for the User ID;
if the respective credit balance for the User ID is greater than a predetermined amount, where the predetermined amount is a function of the priority code:
optically scanning an image; and
storing the scanned image with the electronic address, the priority code and the User ID as a job in a queue of other jobs;
composing an image of the scanned image of the job in the queue where:
the priority code thereof is not less than that of any other job in the queue; and
the relative position thereof is higher that any other job having the same priority code; and
transmitting a network message including the composed image from the digital transmitter device on the network to the electronic address.

16. The computer-readable medium as defined in claim 15, further comprising outputting a diagnostic when the respective balance for the User ID is less than the predetermined amount.

17. The computer-readable medium as defined in claim 15, wherein:
retrieving at the digital transmitter device a respective balance for the User ID comprises retrieving the respective balance for the User ID from a server on the network; and
if the respective balance for the User ID is greater than a predetermined amount, where the predetermined amount is a function of the priority code, the method further comprises deducting the predetermined amount from the respective balance for the User ID and storing the resulting balance for the User ID at the server on the network.

18. The computer-readable medium as defined in claim 15, wherein the digital transmitter device is selected from the group consisting of a digital camera, a hand held scanner, a desk top scanner, a fax machine, a copier, a multifunction peripheral (MFP), and a digital network copier.

19. The computer-readable medium as defined in claim 15, wherein the electronic address is selected from the group consisting of:
an e-mail address at an e-mail server on the network;
a file folder address at a server on the network; and
a Web site address at a server on the network.

20. The computer-readable medium as defined in claim 15, wherein the composed image has a format selected from the group consisting of an ASCII formatted data format, a word processor format, a spread sheet data format, a PDF data format, a Microsoft Power Point® software data format, a GIFF data format, a TIFF data format, a JPEG data format, a bit-map data format, an OCR data format, and an encoded data format.

21. A system comprising:
a network device, in communication with an interconnected network, for storing a respective credit balance amount for each of a plurality of User IDs;
a plurality of digital transmitter devices each having:
a communication link with the interconnected network;
an input device;
means for receiving the respective credit balance for the User ID through the interconnected network;
a scanner to scan at least one object to form corresponding scanned object data;
means for activating said scanner when the respective credit balance for the User ID is greater than a predetermined amount, where the predetermined amount is a function of the priority code;
means for storing the scanned object data, with an electronic address and the priority code as a job in a queue of other said jobs, wherein the electronic address includes an address of a network resource on the interconnected network and a destination location thereat;
means, when the priority code of one said job is not less than that of any other said job in the queue, and the relative position of said one said job is higher that any other said job having the same priority code, for composing the scanned object data into message data; and
means for transmitting the message data over the interconnected network to the electronic address associated with the message data.

22. The system as defined in claim 21, further comprising means for outputting a diagnostic when the respective credit balance for the User ID is less than a predetermined amount, where the predetermined amount is a function of the priority code input at the input device.

23. The system as defined in claim 21, wherein each said digital transmitter device is selected from the group consisting of a digital camera, a hand held scanner, a desk top scanner, a fax machine, a copier, a multifunction peripheral (MFP), and a digital network copier.

24. The system as defined in claim 21, wherein the transmitted message includes data having a format composed by the means for composing that is selected from the group consisting of an ASCII formatted data format, a word processor format, a spread sheet data format, a PDF data format, a Microsoft Power Point® software data format, a GIFF data format, a TIFF data format, a JPEG data format, a bit-map data format, an OCR data format, and an encoded data format.

25. The system as defined in claim 21, wherein the electronic address is selected from the group consisting of:
an e-mail address at an e-mail server on the interconnected network;
a file folder address at a server on the interconnected network; and
a Web site address at a server on the interconnected network.

26. In a digital transmitter device in communication through an interconnected network with a network resource for storing data for each of a plurality of users, the digital transmitter device including an input device, a receiver for receiving the data for the plurality of users from the network resource, a scanner to scan at least one object to form corresponding scanned object data, memory to store the scanned object data and an electronic address of a destination location at the network resource on the interconnected network as a job in a queue of other said jobs, a composer to compose the stored scanned object data for each said job into message data associated with said each said job, a transmitter to transmit the message data over the interconnected network to a designated electronic address, and logic that is configurable to execute a program embodied on a computer-readable medium, the program comprising:
a code segment to activate the scanner when a respective credit balance received for a user input is greater than a predetermined amount, where the predetermined amount is a function of a priority code;
a code segment to activate the composer for one job in the queue when the priority code of said one job is not less than that of any other said job in the queue, and the relative position of said one job is higher that any other said job having the same priority code; and
a code segment to activate the transmitter to transmit the message data associated with said one job.

27. The program as defined in claim 26, further comprising a code segment to output a diagnostic when the respective credit balance received at the receiver for the user input is less than a predetermined amount.

28. The program as defined in claim 26, further comprising a code segment to compose the stored scanned object data for each said job into message data that is in a data format selected from the group consisting of an ASCII formatted data format, a word processor format, a spread sheet data format, a PDF data format, a Microsoft Power Point® software data format, a TIFF data format, a TIFF data format, a JPEG data format, a bit-map data format, an OCR data format, and an encoded data format.

29. The program as defined in claim 26, wherein the digital transmitter device is selected from the group consisting of a digital camera, a hand held scanner, a desk top scanner, a fax machine, a copier, a multifunction peripheral (MFP), and a digital network copier.

30. The program as defined in claim 26, wherein the electronic address is selected from the group consisting of:
an e-mail address at an e-mail server on the interconnected network;
a file folder address at a server on the interconnected network; and
a Web site address at a server on the interconnected network.
